(19) United States
(12) Patent Application Publication
(10) Pub. No.: US 2009/0116764 A1
(43) Pub. Date: May 7, 2009

(54) METHOD OF CONSTRUCTING PANORAMIC ELECTRONIC MAP SERVICE

(76) Inventors: Xiaohua LIU, Shanghai (CN); Dongfang XIE, Shanghai (CN); Xiaofeng HU, Shanghai (CN)

Correspondence Address: MATTHIAS SCHOLL, 14781 MEMORIAL DRIVE, SUITE 1319, HOUSTON, TX, 77079, US

(21) Appl. No.: 12/260,167

(22) Filed: Oct. 29, 2008

Related U.S. Application Data
(63) Continuation of application No. PCT/CN2007/001076, filed on Apr. 3, 2007.

(30) Foreign Application Priority Data
Apr. 29, 2006 (CN) 200610026274.3
Jun. 1, 2006 (CN) 200610027218.1
Jun. 1, 2006 (CN) 200610027219.6
Jun. 13, 2006 (CN) 200610027657.2

(51) Int. Cl. G06K 9/36

(52) U.S. Cl. 382/284

(57) ABSTRACT

A method of constructing panoramic electronic map service, comprising the steps of: 1) collecting panoramic image sequence, namely, collecting panoramic image sequence containing geographic position information and having information continuity between adjacent images; 2) establishing panoramic image database, namely, establishing database containing a panoramic image sequence on a server; 3) establishing position association link, namely, associating the panoramic image sequence in the database with the electronic map via position information; and 4) searching and positioning the panoramic image, namely, when searching, a user can position the geographic information at a searched point on the electronic map by searching for a keyword, and find the corresponding position information in the panoramic image sequence so as to retrieve the panoramic image. The method of the invention can be applied to a conventional electronic map service so as to provide more detailed, specific, and omnidirectional position information.

### CROSS-REFERENCE TO RELATED APPLICATIONS

This application is a continuation of International Patent Application No. PCT/CN2007/001076, with an international filing date of Apr. 3, 2007, designating the United States, now pending, which is based on Chinese Patent Application Numbers 200610026274.3 filed on Apr. 29, 2006, 200610027218.1 filed on Jun. 1, 2006, 200610027219.6 filed on Jun. 1, 2006 and 200610027657.2 filed on June 13, the contents of these specifications are incorporated herein by reference.

### BACKGROUND OF THE INVENTION

1. Field of the Invention

The invention relates to methods for constructing electronic map service, and especially, to a method of constructing panoramic electronic map service with which the user can inquire and obtain a 360 degree panoramic information.

2. Description of the Related Art

In recent years, online map searching services became popular. Conventional searching service providers, such as Google, MSN, Yahoo, Sina, Baidu, and so on, are all promoting their own electronic map searching service. This searching service provides convenient, flexible, and efficient tour reference to the users. With this service, the user can easily get the position information on a map. For example, a user can easily get the position of Shanghai Pudong Software Park. By searching particular position characteristics, specific places, such as restaurants, shopping malls, parking lots, etc, can be located easily. Electronic map searching service is increasingly becoming a convenient tool in people's daily lives.

Panoramic technology is an important part of virtual reality system, and comprises image-based drawing technology. Since pixel elements in a panoramic image are obtained by interpolating pixel elements of specific sample images, the drawing is not related to the complexity of the image setting, and the reality sensation of the panoramic image is perceived in the same way as a picture. Using panoramic technology, a user can view entire information in 360×180 degrees, as if the user were standing at the collecting point to view in all directions. Panoramic technology offers a user special characteristics to straightforwardly and omnidirectionally view the entire space information expressed by the panoramic image, and therefore is applied widely in the industries such as real estates, tourism, etc.

In the field of drawing panoramic images, China Pat. No. CN1437165A published Aug. 20, 2003 disclosed a panoramic image generation method based on two fish eye images, China Pat. No. CN1707353A published Dec. 14, 2005 disclosed a method of generating spherical panoramic image based on full frame image, China Pat. No. CN1707354A published Dec. 14, 2005 disclosed a method of quickly generating high definition panoramic image based on round fish eye or drum image, and China Pat. No. CN1707355A published Dec. 14, 2005 disclosed a method of generating whole spherical panoramic image based on six drum images.

However, by utilizing conventional electronic map services, a user can only get position information related to the searching point but is not given any additional necessary and useful details. To illustrate, when changing a bus at a bus station, a user of a conventional electronic map searching service may still be confused by many cross-roads and flyovers. To illustrate further, a user wishing to find information about parking lots close to a particular business may not be able to locate small outdoor parking lots and may be referred to a large parking lot away. To illustrate further, a user wishing to locate a bank on a certain road may discover that the address provided on the electronic map is not correct, and may have to walk a distance from the displayed location. In these three situations, a user would benefit from being able to view the real scenery from the perspective of the search position in order to make a correct decision.

Certain conventional online map service providers have introduced panoramic image into the map searching service, such as the panoramic map provided by MAPABC (http://www.mapabc.com). However, the expression form of the panoramic image in a conventional electronic map service is difficult to fit the requirements of a user. For example, with the expression form of the panoramic map provided by MAPABC, the user can see the position point and text link containing panoramic image by entering into the homepage of the panoramic map, then the panoramic image can be displayed by clicking a link or a position point. However, since the information collection is limited, the panoramic image of the searching position cannot be seen by most of the users, and the expression form of the panoramic image is passive. Namely, the panoramic image of a certain position may not be found and displayed; the user can only see a panoramic image of a searching position provided with panoramic images.

Meanwhile, the above panoramic image does not provide any position information, the name must be associated with the address, or the panoramic image has to be positioned onto the electronic map by marking the electronic map. If the quantity of the panoramic image reaches a certain amount, the searching capacity will be overloaded, the searching efficiency will be low, and the searching operability will be limited. Furthermore, many collecting point may not have a common name; e.g., when 25 pieces of panoramic images are collected along a 500 m long greenbelt without any doorplate and landmark building, a name has to be set on the electronic map to associate with the name for the panoramic images. However, since the user is not familiar with the name, the searching experience is not attractive. If the association is realized by marking on the electronic map, since the position sense of the scaled streets on the electronic map is weak, it is difficult for the user to position the collected panoramic image to the electronic map by naked eye, influencing negatively the searching experience. Besides, in a conventional searching mode, there is no overlap between the panoramic images, the user cannot see information close to the panoramic image when searching, and the information obtained is not continuous.

On the searching side, a user normally inputs the name of a certain position, only the panoramic images having the same or similar name rules can be displayed, while the panoramic image of a random street position cannot be displayed. In fact, a conventional searching mode cannot provide much actual help for people's daily lives. It is too far to satisfy the user's searching requirement by providing the panoramic images only for some sceneries and asking the user to search for concerned information within these panoramic images. On the contrary, actual help to people's daily lives can be realized only by providing panoramic images for any available searching position on the electronic map.

### SUMMARY OF THE INVENTION

In order to obtain actual image information at a searched point when a user is searching through the electronic map, it is one objective of the present invention to provide a panoramic electronic map service and a method of constructing thereof based on a conventional electronic map, wherein a continuous panoramic image sequence containing geographic position information is introduced.

The panoramic image sequence has a one-to-one correspondence with respect to a specific position, such as a street, a community, etc, via position change relationship. Therefore, when searching a certain area, the user can understand the detailed environmental and positional information at a searched point using the panoramic electronic map. Namely, by inputting a house number, name or by clicking on the map, the panoramic image at a searched point can be seen and the required information can be obtained by viewing the panoramic image. Since the information expressed by the panoramic image sequence is continuous, the user can continuously view the previous and next panoramic images and their surrounding environmental information.

In order to realize the above objective, provided is also a method of constructing a panoramic electronic map service capable of providing detailed, specific, and live map searching service. In certain embodiments of the invention, by collecting continuous panoramic image sequence containing position information, the panoramic image is associated with an electronic map via positional information. Since the panoramic image is capable of expressing the entire space information, and two adjacent images have a certain degree of overlap, the user can understand and appreciate in a straightforward manner positional situation at a searched point and the surrounding areas enabling the user to make accurate and clear judgments and decision.

In certain embodiments of the invention, a method of constructing panoramic electronic map service of the invention comprises the steps of: 1) collecting a panoramic image sequence, namely, a collecting panoramic image sequence containing geographic position information and having a previous and next image information continuity;

2) establishing a panoramic image database, namely, establishing a database containing the panoramic image sequence in a server;

3) establishing a position association link, namely, associating the panoramic image sequence in the database with the electronic map via position information; and

4) searching and positioning the panoramic image.

In certain embodiments of the invention, when searching, a user can position the geographic information at a searched point on the electronic map by searching for a keyword or by clicking the map, and also find corresponding position information in the panoramic image sequence so as to retrieve the panoramic image.

Optionally, a user can find a corresponding panoramic image by searching for a keyword, and position the image position on the map according to the position information of the panoramic image.

Furthermore, a user can retrieve the previous and next panoramic images with respect to the current image by triggering the front and back motions of the panoramic image sequence.

As a result, since the panoramic service function is added to a conventional map service, the user can obtain the searching results with continuous panoramic information when searching for any street or community position within the areas containing panoramic resource.

Since the panoramic image is real and the space information is complete, a user can obtain more information by viewing and analyzing the panoramic image so as to make more accurate judgment and analysis.

### BRIEF DESCRIPTION OF THE DRAWINGS

The present invention will hereinafter be described further according to the drawings and relevant embodiments, in which

FIGS. 1a and 1b illustrates a conventional electronic map service and the expression mode of a panoramic electronic map;

FIGS. 2a and 2b illustrate a conventional sphere panoramic image and its perspective view;

FIG. 3 illustrates a process for constructing a panoramic electronic map service in accordance with one embodiment of the invention;

FIGS. 4-1 through 4-6 illustrate a principle of collecting the panoramic image sequence in accordance with one embodiment of the invention;

FIGS. 5-1 through 5-3 illustrate a method of establishing a link between the panoramic image and the electronic map in accordance with one embodiment of the invention; and

FIG. 6 illustrates a panoramic electronic map service in accordance with one embodiment of the invention.

### DETAILED DESCRIPTION OF THE EMBODIMENTS

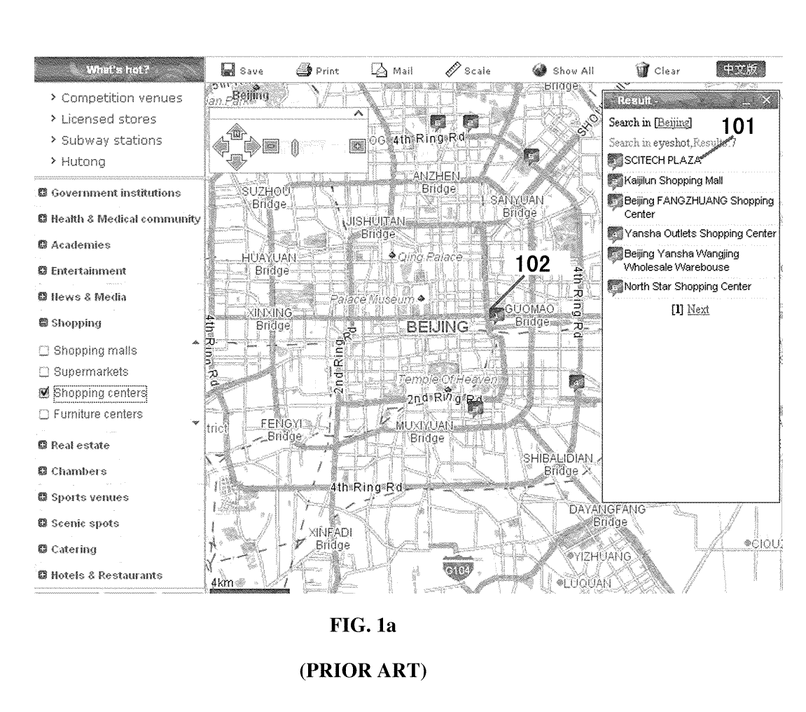

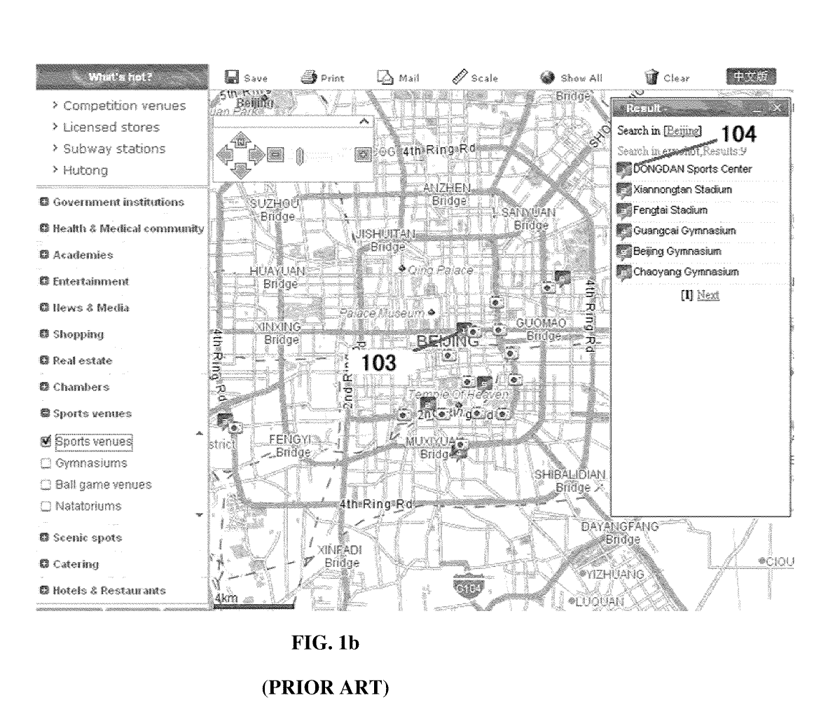

FIG. 1 illustrates a conventional electronic map service mode and an electronic map expression mode with the addition of panoramic image. Specifically, FIG. 1a illustrates a searching result screen shot for a searching area of Beijing and a searching word of business center based on a conventional electronic map service. Area 101 expresses the text searching results. Area 102 shows the positions of the searching results on the electronic map. The numbers in areas 101 correspond to the marks in areas 102, expressing that the geographic position shown in area 102 is the position shown by the number in area 101.

FIG. 1b illustrates an expression mode of a conventional electronic map with the addition of panoramic image. Area 104 expresses the position name having panoramic images. Area 103 illustrates a camera list diagram in the electronic map. Each camera point means that the point contains panoramic image. From the quantity of the cameras, it can be seen that the quantity of the camera is limited. Accordingly, the quantity of the panoramic images is limited as well. The user can click the position name with panoramic image in the area 104 or click the camera icon on the electronic map to enter into a new page for viewing panoramically. As can be seen from area 101, the searching result does not contain panoramic image. As can be seen from area 102, the electronic map only contains some local and scattered panoramic image points, so that the reference and help provided to the user is limited in conventional solutions.

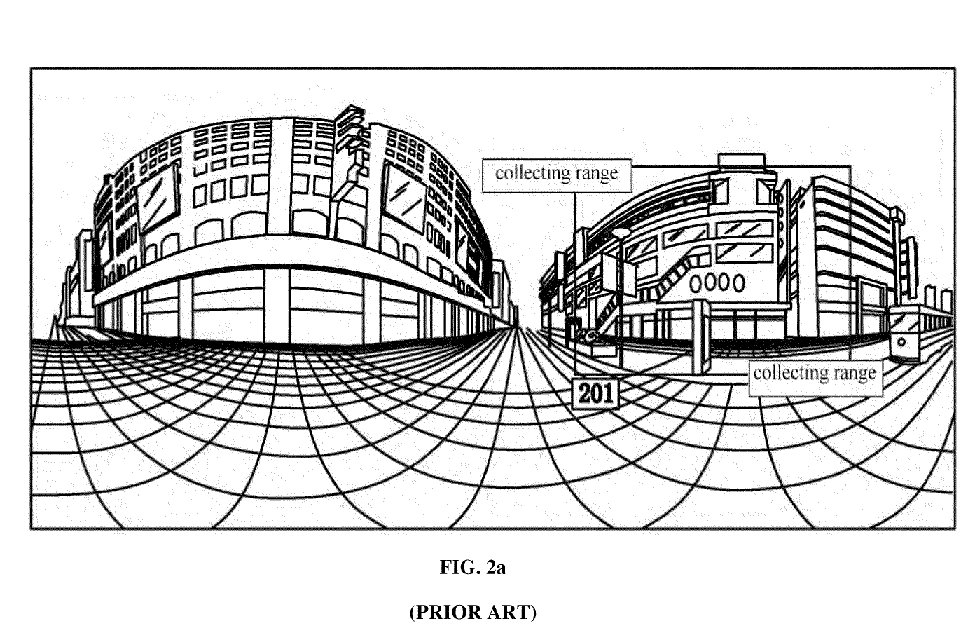

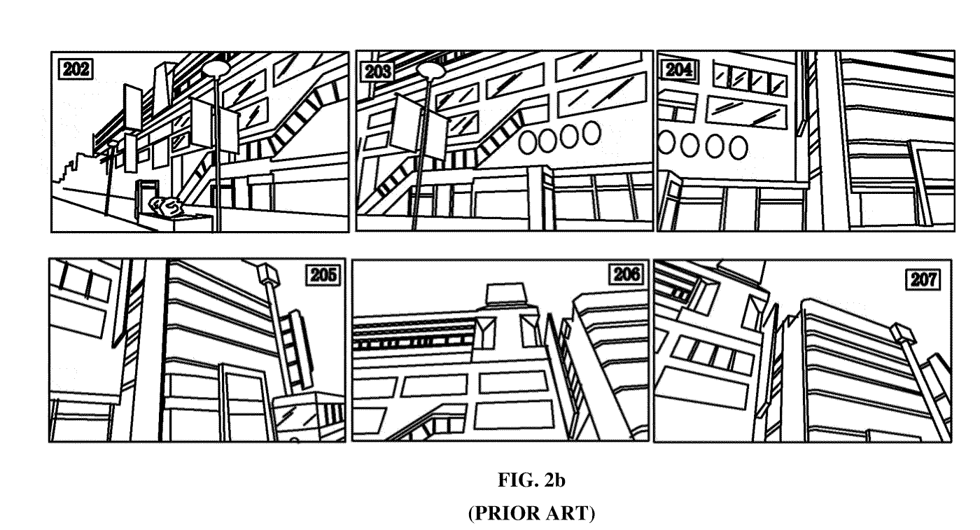

FIGS. 2a and 2b illustrate a sphere panoramic image and its perspective exploded view. FIG. 2a is an original sphere panoramic image. FIG. 2b illustrates a 6-piece screen shot reflecting views from different directions taken from the rectangular area 201 in a collecting range shown in FIG. 2a. The 6-piece screen shot corresponds to different perspective parameter settings, which determine the view angular range for the user. Specifically, the information presented through the perspective window is continuous, so that the user can view images continuously by dragging the mouse or using keyboard. In addition to a sphere type, the panoramic image can also be in a form of a column, a cubic, a circle, etc.

The sphere panoramic image and its perspective view of FIG. 2 can be obtained using methods disclosed by China Pat. Nos. CN1437165A, CN1707353A, CN1707354A, and CN1707355A. A detailed description of these methods is omitted herefrom.

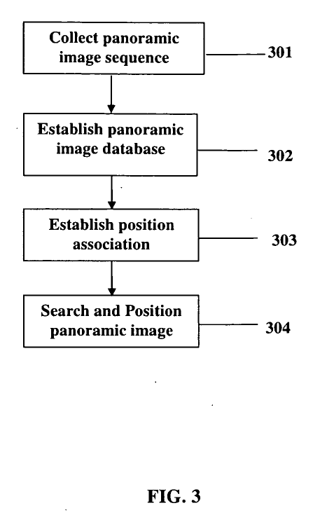

FIG. 3 illustrates a process for constructing a panoramic electronic map service in accordance with one embodiment of the invention. The process comprises the steps of: collecting panoramic image sequence 301; establish panoramic image database 302; establishing position association between the omnidirectional real position and the two-dimensional electronic map 303; and searching and positioning the panoramic image 304. In step of 301, panoramic image sequence containing geographic position information and having previous and next image information continuity is collected, and a database containing the panoramic image sequence in established on a server.

In the present invention, the geographic position information in the collected image sequence must be unique information capable of describing or representing any position point, and includes but is not limited to GIS information, longitude and latitude information, a unique ID identifier, etc. When collecting image information, geographic position information (GIS) at the image position can be obtained with a GPS device. Optionally, the position information can be a longitude and latitude information, or a unique ID identifier converted from the GIS information.

In the present invention, the continuity of the previous and next information means that the two adjacent panoramic images in the image sequence have a certain overlap area. Namely, a part of the image information of a former image can be found in the next image so as to ensure the continuity of the images for user viewing.

In the present invention, the collecting distance of two adjacent images is within a range of 50 m. When collecting, the collecting distance can be adjusted, e.g., according to the width of the road to ensure a certain degree of overlap between the adjacent panoramic images. The panoramic image described in the panoramic electronic map of the invention can be but does not need to be in the form of a sphere and a semi-sphere, a column, a partial column, a cubic, a partial cubic, a circle and a semi-circle. Each panoramic image can be obtained using different collecting devices or using a combination of collecting devices.

In the present invention, the panoramic image sequence containing geographic position information comprises at least one panoramic image with position information. In fact, it is important that the position information of the panoramic image is accurate to position precisely the panoramic image onto the electronic map. When the position information of a panoramic image is missing, this can be remedied through methods such as interpolating the adjacent image position information.

Step 302 in FIG. 3 is to establish a database containing the panoramic image sequence on a server. Using a database, the panoramic image sequence can be managed effectively, and the required panoramic image can be found quickly and efficiently.

Step 303 in FIG. 3 is to establish position association between the omnidirectional real position and the two-dimensional electronic map. Namely, the panoramic image sequence in the database is associated with the electronic map through position information. All positions on the electronic map have a unique position information identifier, including but not limited to GIS information, longitude and latitude information, etc. Correspondence between the position information identifier of the electronic map and the position information of the panoramic image ensures that the position information of the panoramic image is unique on the electronic map.

Meanwhile, all positions on the electronic map have a corresponding panoramic image relative to the position or the closest position in the panoramic image sequence. In addition, the panoramic image sequence also has an angular correspondence with the physical space. When the panoramic image is being displayed on the panoramic image player, its correspondent view angle can be displayed in a form of radar orientation on the map. The angular correspondence relationship can be determined according to the direction of collecting, compass information, or in other ways.

Step 304 in FIG. 3 is to search and position the panoramic image. Namely, when searching, the searching point can be positioned on the electronic map by searching a keyword or by clicking the map directly. Then, the position information corresponding to the panoramic image sequence can be found according to the GIS information, longitude and latitude information, or unique ID identifier at a searched point to retrieve the panoramic image. Specifically, the position at a searched point refers to the position information at a searched point on the electronic map. By searching one keyword, the searching function of the electronic map system can match out the key point set for displaying. Since each key point is related to one position information in the electronic map such as GIS, the position information of the key point corresponding to the panoramic sequence set can be obtained through a change relationship between the position information of the electronic map and that of the panoramic image. Panoramic image satisfying requirements can be found by searching for a keyword and matching the keyword in the identifiers of the panoramic image, and the position of the image on the map can be positioned according to the specific position information. The user can also control the previous and next motion of the panoramic image sequence to retrieve other panoramic images according to demand.

In the present invention, the link connection between the panoramic image and the electronic map is easy to realize for skilled in the art.

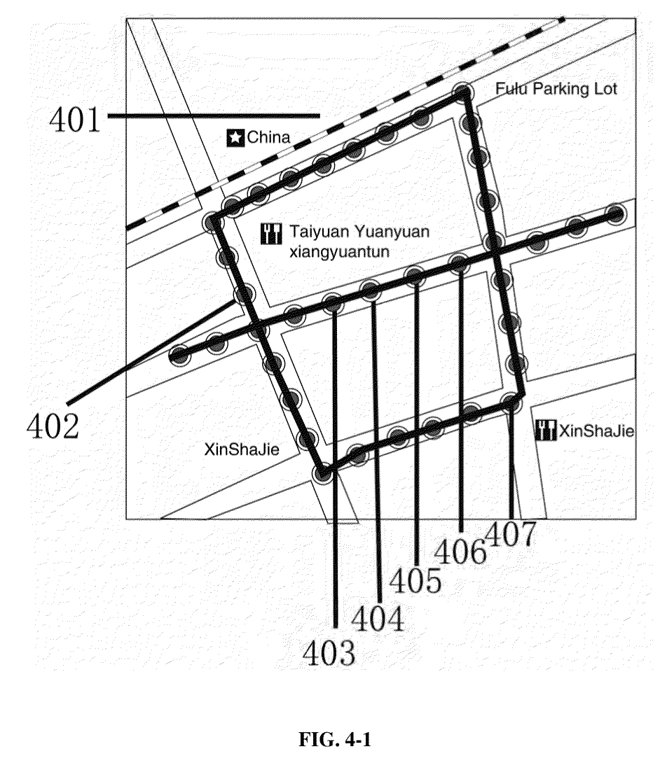

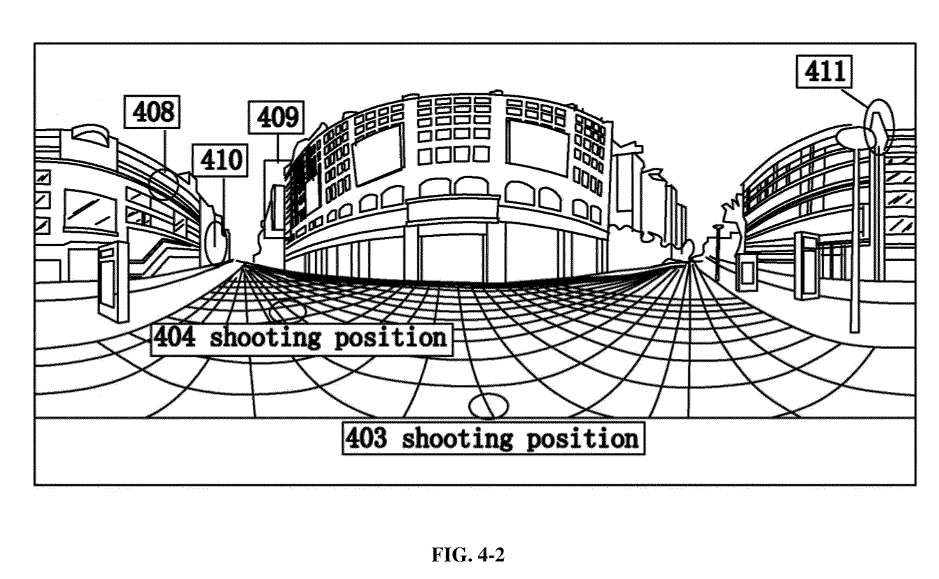

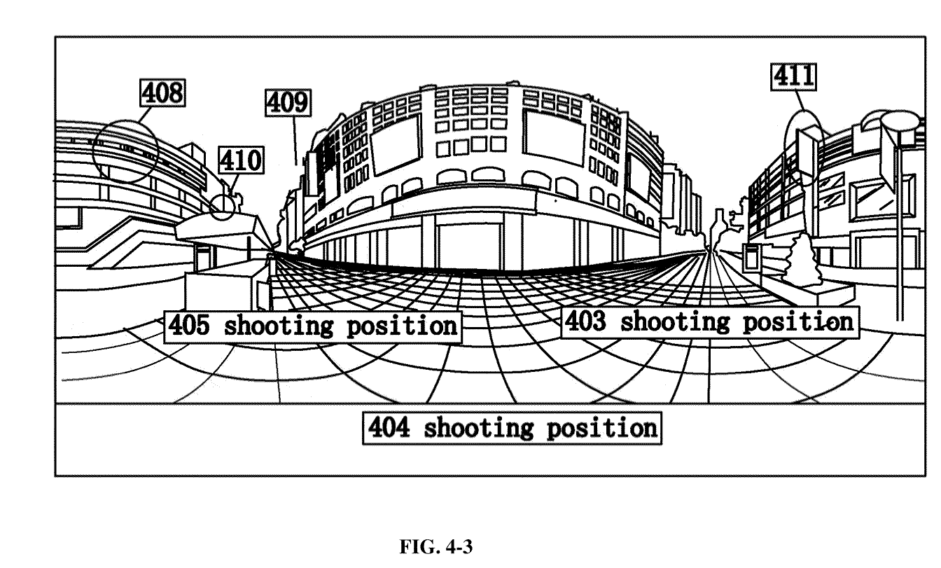

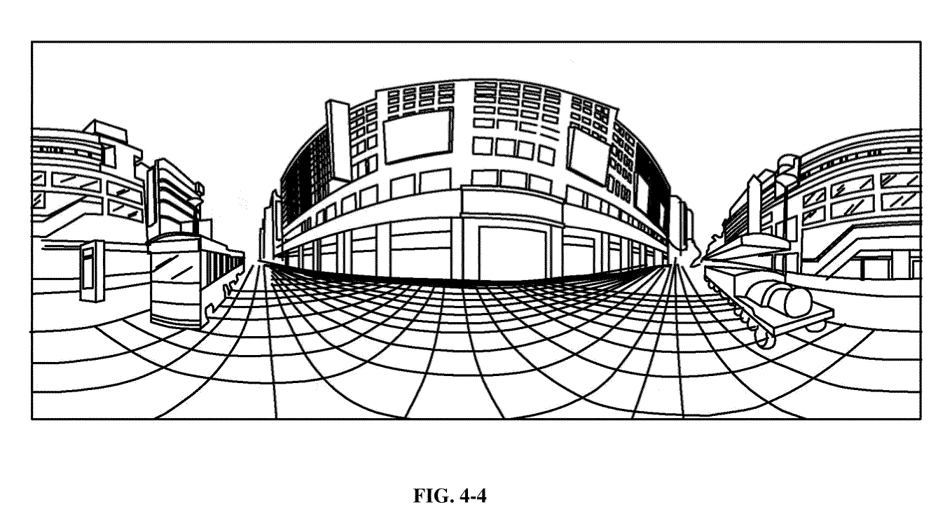

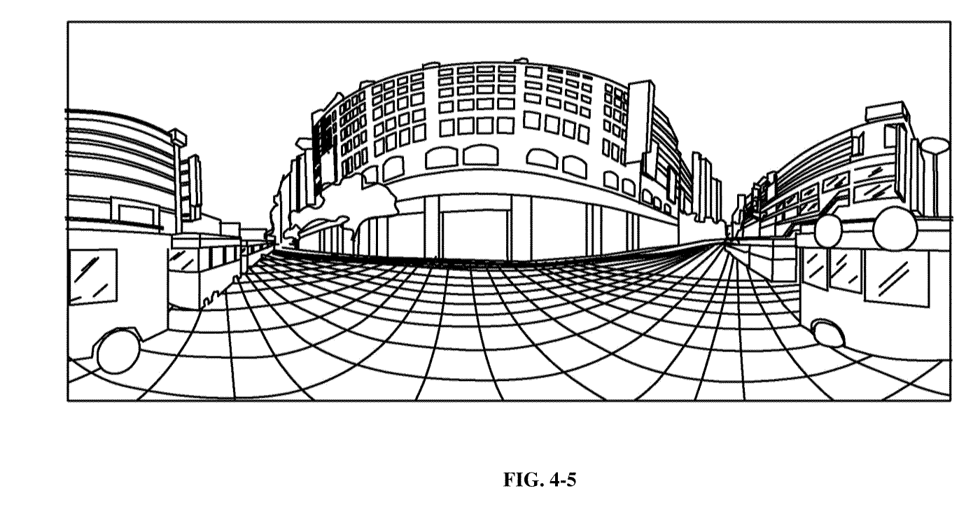

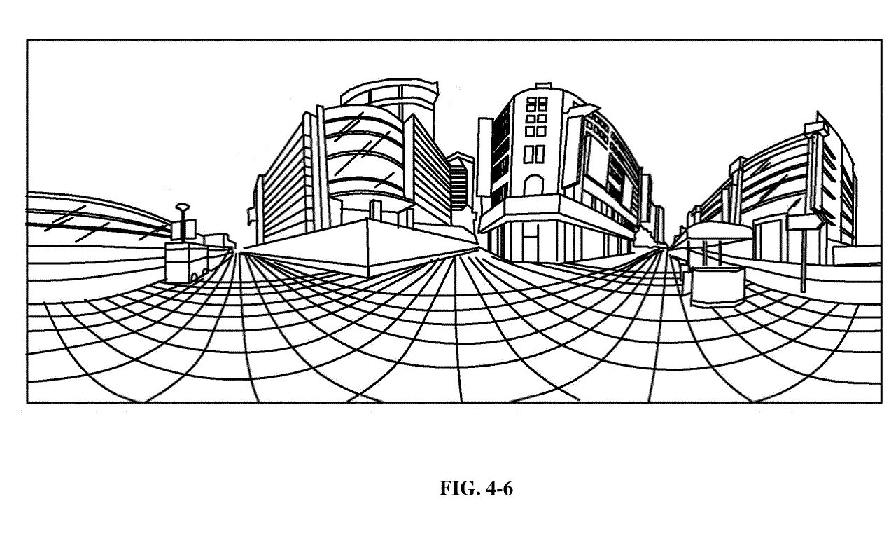

FIGS. 4-1 through 4-6 illustrate the principle of collecting a panoramic image sequence in accordance with the invention. FIG. 4-1 serves to explain the basic principle of collecting the panoramic image sequence. The panoramic image is collected along the road every certain distance, and the position information of the image is collected simultaneously. For the road shown in FIG. 4-1, the black arrows represent the image collecting direction, and the round points represent the collecting points of the panoramic images. The collecting principle of the panoramic image sequence is described in accordance with the collecting points of 403 to 407. The images collected at collecting points 403, 404, 405, 406, and 407 correspond to the images in FIGS. 4-2, 4-3, 4-4, 4-5, and 4-6, respectively. From FIGS. 4-2 through 4-6, it is clear that there is a lot of overlap between adjacent images. For example, the two collecting points 403 and 404 in FIG. 4-2 also appear in FIG. 4-3. To describe further the information overlap between the two adjacent images, the distinguishing feature identifiers 408, 409, 410, and 411 in FIG. 4-2 are the same as those shown in FIG. 4-3, though their positions are different in different images collected from different collecting points. The same features also clearly appear in FIGS. 4-4 through 4-6.

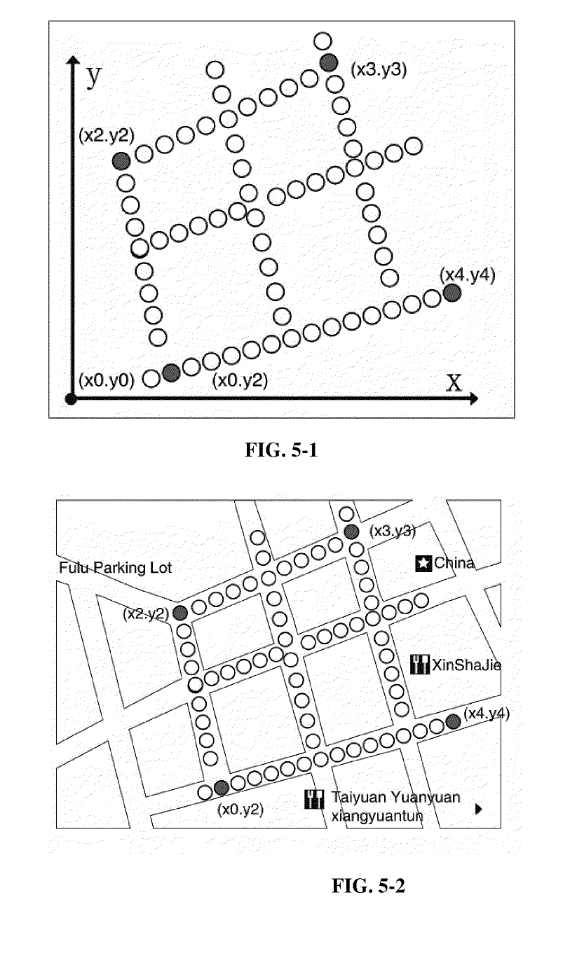

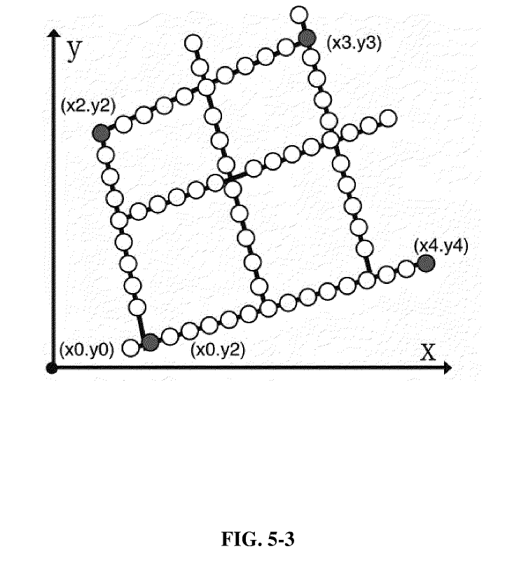

FIGS. 5-1 though 5-3 illustrate a method of establishing a link between the panoramic image and the electronic map in accordance with one embodiment of the invention. The round points in FIG. 5-1 are position points at which images are taken in the panoramic image sub-sequence. The set of these points illustrates the space distribution of the sub-sequence and has a planar mesh structure. Since the panoramic images are collected along the road, the GIS coordinates of the image position points are recorded using a terminal machine such as GPS receiver, so that the images can be associated with the electronic maps easily via position coordinates. As shown in FIG. 5-2, the mesh structure is added to the electronic map. The round points are all located on the road, which is consistent with the collecting principle.

FIG. 5-3 illustrates the round points connected through lines in accordance with the feature of the mesh structure. For comparison, the connection line in FIG. 5-3 is identical with the road in FIG. 5-2, which is also consistent with the collecting principle. In operation, establishing a connection relationship among the round points is one of the realization forms for associating with the image sequence. When traversing the round points within the mesh structure, adjacent image display in the panoramic image sequence can be realized. Meanwhile, if the position coordinate of the displaying panoramic image is changed, the correspondent image position on the electronic map also will be changed.

On the operation panel, when clicking the “previous” or “next” button of the panoramic image sequence, the “previous” or “next” panoramic image can be displayed accordingly, and the position of the “previous” or “next” panoramic image and the displaying angle will be displayed on the map. The following features are included:

1) the click action refers to a behavior to switch the “previous” or “next” panoramic image, including but not limited to single click, double click, keyboard operation, and so on;

2) the “previous” or “next” button can be a real interface element representing the “previous” or “next” panoramic image, or can be a logical definition without interface element, such as a logical behavior of operating the ArrowUp key of the keyboard to show the “previous” or “next” panoramic image;

3) the action of clicking the “previous” or “next” button of the panoramic image sequence also includes a behavior of switching automatically to the “previous” or “next” panoramic image defined by software;

4) the panoramic image played through the panoramic image player contains angle information capable of representing an angle relationship between the displaying perspective scenery and the real physical space, so that when playing a panoramic image, the corresponding playing angle of the panoramic image can be displayed at the physical position of the current panoramic image; and

5) when running “previous” or “next” operation according to the position point on the map, the panoramic image sequence will respond and switch to the panoramic image of the position or the closest position corresponding to the display point of the current map.

Besides, the above planar mesh structure can also be a more complicated space mesh structure. When collecting on a flyover bridge and the roads below the flyover bridge simultaneously, two data sets will appear on the same road routine. Then, the space mesh structure can be built logically. Similarly, when repeatedly collecting images on the same road, different data sets can be included for one road accordingly.

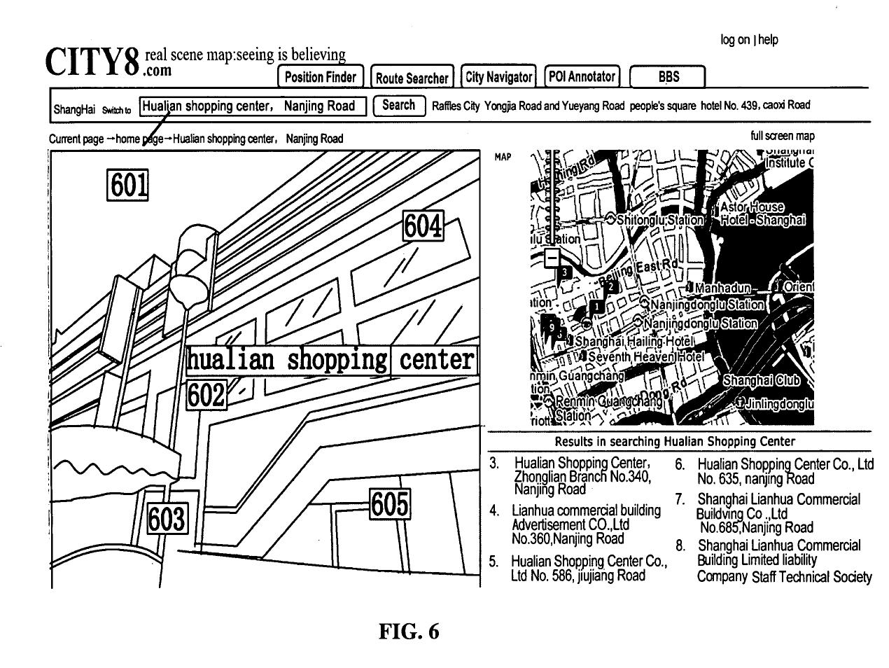

FIG. 6 illustrates a panoramic electronic map service in accordance with one embodiment of the invention. The search content is the same as that of FIG. 1. Elements 601, 602, 603, 604, and 605 represent text display area, panoramic image display area, control button area, electronic map display area, and relevant search area, respectively. A panoramic image is provided in FIG. 6. Compared with FIG. 1, the place is displayed three-dimensionally, so that the user can see clearly the situation and the facilities around that place. When clicking the previous or next button of the panoramic image sequence in the area 603 to display the previous or next image, the corresponding position on the electronic map will also be changed to display accordingly. The association between the map and the panoramic image offers the user a better sense of position and direction.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. A method of constructing a panoramic electronic map service, comprising the steps of:
1) collecting a panoramic image sequence comprising a plurality of panoramic images;
2) establishing a database comprising said panoramic image sequence;
3) establishing a position association link between an electronic map and said panoramic image sequence; and
4) optionally, searching and positioning said panoramic images.

2. The method of claim 1, wherein said panoramic image sequence comprises geographic position information and has an adjacent image information continuity.

3. The method of claim 2, wherein said geographic position information comprises any unique information capable of describing or representing a geographic position.

4. The method of claim 2, wherein said geographic position information is geographic position information (GIS), longitude and altitude information, or an ID identifier.

5. The method of claim 2, wherein said adjacent image information continuity comprises overlap between two adjacent panoramic images.

6. The method of claim 2, wherein a part of image information contained in a first image is found in an adjacent image.

7. The method of claim 2, wherein said panoramic image is a sphere panoramic image, a partial sphere panoramic image, a column panoramic image, a partial column panoramic image, a cubic panoramic image, a partial cubic panoramic image, a circular panoramic image, a partial circular panoramic image, or a combination thereof.

8. The method of claim 2, wherein said panoramic image sequence comprises at least one panoramic image containing position information.

9. The method of claim 1, wherein said panoramic image sequence is associated with said electronic map through position information.

10. The method of claim 1, wherein said position information comprises a unique position information identifier.

11. The method of claim 10, wherein said unique position information identifier comprises GIS information, or longitude and altitude information.

12. The method of claim 9, wherein said position association link comprises a corresponding and unique position on said electronic map for said position information of the panoramic image in said image sequence.

13. The method of claim 7, wherein establishing said position association link comprises finding a panoramic image in said panoramic image sequence corresponding to a position on the electronic map.

14. The method of claim 7, wherein establishing said position association link comprises displaying a previous or a next image in said panoramic image sequence while displaying a corresponding position on said electronic map.

15. The method of claim 1, wherein said searching and positioning panoramic image means that when a user is searching, a geographic position at a searched point is positioned on said electronic map by searching a keyword or by clicking on said map, and a corresponding position information in said panoramic image sequence is located by using said position information to retrieve said panoramic image.

16. The method of claim 1, wherein said searching and positioning panoramic image means that a user finds a panoramic image by searching for a keyword, and the image is positioned on the map using position information of said panoramic image.

17. The method of claim 1, wherein said searching and positioning panoramic image means that a user retrieves a previous and a next image by triggering a previous and a next motion of the panoramic image sequence, respectively.
